(19) United States
(12) Patent Application Publication
(10) Pub. No.: US 2026/0360373 A1
(43) Pub. Date: Nov. 12, 2026

(54) ELECTRONIC DEVICE AND METHOD FOR AUDIO PROCESSING

(71) Applicant: SAMSUNG ELECTRONICS CO., LTD., Suwon-si (KR)

(72) Inventors: Kyungrae KIM, Suwon-si (KR); Hyunkwon CHUNG, Suwon-si (KR); Yongmin KWON, Suwon-si (KR); Woohyun NAM, Suwon-si (KR); Yoonjae SON, Suwon-si (KR); Chaebin IM, Suwon-si (KR)

(73) Assignee: SAMSUNG ELECTRONICS CO., LTD., Suwon-si (KR)

(21) Appl. No.: 19/722,065

(22) Filed: Jun. 26, 2026

Related U.S. Application Data
(63) Continuation of application No. PCT/KR2024/020699, filed on Dec. 19, 2024.

(30) Foreign Application Priority Data
Dec. 28, 2023 (KR) 10-2023-0195351

(51) Int. Cl. G10L 19/008; H04S 3/00; H04S 7/00

(52) U.S. Cl. CPC G10L 19/008; H04S 3/008; H04S 7/302; H04S 2400/01; H04S 2400/11

(57) ABSTRACT

An audio processing method of an electronic device, the audio processing method including: determining, as a key object audio signal, at least one object audio signal among a plurality of object audio signals; determining, as a sub-object audio signal, an object audio signal, other than the key object audio signal, among the plurality of object audio signals; obtaining a multi-channel audio signal by using the key object audio signal and the sub-object audio signal; and generating a bitstream by compressing the key object audio signal and the multi-channel audio signal.

### CROSS-REFERENCE TO RELATED APPLICATIONS

This application is a continuation of International Application No. PCT/KR2024/020699, filed on Dec. 19, 2024, which is based on and claims priority to Korean Patent Application No. 10-2023-0195351 filed on Dec. 28, 2023, in the Ministry of Intellectual, Republic of Korea, the disclosures of which are incorporated by reference herein in their entireties.

### BACKGROUND

### 1. Field

The disclosure relates to an electronic device and method for audio processing.

### 2. Description of Related Art

Channel based audio is audio in which a plurality of audio signals are output in a predefined channel layout and is an audio signal output method by which a channel through which a plurality of audio signals are to be transmitted is predetermined.

Object based audio is an audio implementation that allows users to experience immersive sound, which is the sound of an object moving in three-dimensional space and is an audio signal output method by which a speaker for output is determined based on spatial information of the object, rather than a predefined channel layout.

### SUMMARY

According to an aspect of the disclosure, there is provided an audio processing method of an electronic device, the audio processing method including: determining, as a key object audio signal, at least one object audio signal among a plurality of object audio signals; determining, as a sub-object audio signal, an object audio signal, other than the key object audio signal, among the plurality of object audio signals; obtaining a multi-channel audio signal by using the key object audio signal and the sub-object audio signal; and generating a bitstream by compressing the key object audio signal and the multi-channel audio signal.

According to an aspect of the disclosure, there is provided an audio processing method of an electronic device, the audio processing method including: decompressing a bitstream to obtain a key object audio signal and a first multi-channel audio signal in which the key object audio signal and a sub-object audio signal are rendered; based on determining the electronic device is not capable of outputting the key object audio signal, obtaining a second multi-channel audio signal that is to be output from the electronic device based on the first multi-channel audio signal and information about a channel layout of the electronic device; and based on determining the electronic device is capable of outputting the key object audio signal, obtaining a third multi-channel audio signal that is to be output from the electronic device by using the key object audio signal and the first multi-channel audio signal.

According to an aspect of the disclosure, there is provided an electronic device including: memory storing one or more instructions; and at least one processor configured to execute the one or more instructions stored in the memory, wherein the one or more instructions, when executed by the at least one processor individually or collectively, cause the electronic device to: determine, as a key object audio signal, at least one object audio signal among a plurality of object audio signals, determine, as a sub-object audio signal, an object audio signal, other than the key object audio signal, among the plurality of object audio signals, obtain a multi-channel audio signal by using the key object audio signal and the sub-object audio signal, and generate a bitstream by compressing the key object audio signal and the multi-channel audio signal.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram for explaining an electronic device according to an embodiment of the present disclosure;

FIG. 2 is a flowchart for explaining an audio encoding method of an electronic device, according to an embodiment of the present disclosure;

FIG. 3 is a diagram for explaining spatial information of an object corresponding to an object audio signal, according to an embodiment of the present disclosure;

FIG. 4 is a flowchart for explaining a method of pre-processing a key object audio signal, according to an embodiment of the present disclosure;

FIG. 5 is a block diagram for explaining an audio encoding method according to an embodiment of the present disclosure;

FIG. 6 is a block diagram for explaining an electronic device that performs audio encoding, according to an embodiment of the present disclosure;

FIG. 7 is a flowchart for explaining an audio decoding method of an electronic device, according to an embodiment of the present disclosure;

FIG. 8 is a flowchart for explaining a method of rendering a first multi-channel audio signal, according to an embodiment of the present disclosure;

FIG. 9 is a block diagram for explaining an electronic device that performs audio decoding, according to an embodiment of the present disclosure;

FIG. 10 is a flowchart for explaining an audio processing method of an electronic device, according to an embodiment of the present disclosure;

FIG. 11 is a schematic block diagram of an electronic device that performs an audio processing method, according to an embodiment of the present disclosure; and

FIG. 12 is a detailed block diagram of an electronic device according to an embodiment of the present disclosure.

### DETAILED DESCRIPTION

Hereinafter, embodiments of the present disclosure are described in detail with reference to the attached drawings.

The present disclosure may have various modifications and embodiments, and thus certain embodiments are illustrated in the drawings and described in detail through the detailed description. However, this is not intended to limit the embodiments of the present disclosure, and it needs to be understood that the present disclosure includes all modifications, equivalents, and alternatives included in the spirit and technical scope of the various embodiments.

In describing the embodiments, when it is determined that a detailed description of a related known technology may unnecessarily obscure the gist of the present disclosure, the detailed description is omitted. Numbers used in the description of the specification (e.g., first, or second) are merely identifiers to distinguish one component from another.

The terms used in the present disclosure are selected from the most widely used general terms possible while considering the functions of the present disclosure, but may vary depending on the intention of engineers in the field, precedents, the emergence of new technologies, and the like. In certain cases, there are terms arbitrarily selected by the applicant, and in such cases, their meanings are described in detail in the corresponding description of an embodiment of the present disclosure. Therefore, the terms used in the present disclosure need to be defined based on the meaning of the terms and the overall content of the present disclosure, rather than simply the names of the terms.

The scope of the present disclosure may be indicated by the claims set forth below rather than by the detailed description above. Various features described in one claim category of the present disclosure (e.g., in a method claim) may also be claimed in another claim category (e.g., in a system claim). An embodiment of the present disclosure may include not only combinations of features specified in the appended claims, but also various combinations of individual features within the claims. The scope of the present disclosure should be interpreted to include all changes or modifications derived from the meaning and scope of the claims and their equivalent concepts.

Components expressed as ‘unit’, ‘module’, and the like in the present disclosure may be two or more components combined into one component, or one component may be divided into two or more components according to more detailed functions. This function may be implemented by hardware, software, or a combination thereof. Each component described below may additionally perform some or all of the functions performed by other components in addition to its own main function, and some of the main functions performed by each component may be performed exclusively by other components.

The singular expressions include the plural expressions unless clearly specified otherwise in context. All terms including technical and scientific terms used herein have the same meaning as commonly understood by those of skill in the art to which the present disclosure belongs.

In the present disclosure, a processor is a configuration that controls a series of processes such that an electronic device operates according to the embodiments described below, and may include one or more processors. One or more processors included in the processor may be a circuitry such as a system on chip (SoC), or an integrated circuit (IC). One or more processors included in the processor may be a general-purpose processor such as a central processing unit (CPU), a micro processor unit (MPU), an application processor (AP), or a digital signal processor (DSP), a graphics-only processor such as a graphics processing unit (GPU), or a vision processing unit (VPU), an artificial intelligence (AI)-only processor such as a neural processing unit (NPU), or a communication-only processor such as a communication processor (CP). When one or more processors included in the processor are AI-dedicated processors, the corresponding AI-dedicated processors may be designed with a hardware structure specialized for processing a certain AI model.

In the present disclosure, the processor may include various processing circuits and/or a plurality of processors. For example, the term “processor” as used herein, including in the claims, may include various processing circuits, including at least one processor. One or more processors of at least one processor, may be configured to individually and/or collectively perform the various functions described herein in a distributed manner. As used herein, “processor,” “at least one processor,” and “one or more processors” may be configured to perform a variety of functions. However, these terms cover, without limitation, a situation in which one processor performs some of the functions and other processor(s) perform other parts of the functions, and a situation in which a single processor is capable of performing all of the functions. At least one processor may include a combination of processors that perform various functions of the disclosed functions in a distributed manner. At least one processor may execute program instructions to accomplish or perform various functions.

It should be understood that the blocks and combinations of the flowcharts in each of the flowcharts in the present disclosure may be performed by one or more computer programs including computer-executable instructions. One or more computer programs may be stored entirely in a single memory, or may be split across a plurality of different memories.

Any function or operation described in the present disclosure may be performed by a single processor or a combination of processors. A processor or a combination of processors is a circuitry that performs processing, and may include a circuitry such as an application processor (AP), a communication processor (CP), a graphical processing unit (GPU), a neural processing unit (NPU), a microprocessor unit (MPU), a system on chip (SoC), or an integrated chip (IC).

The processor may write data to memory, read data stored in memory, and in particular, execute a program or at least one instruction stored in memory to process data according to a predefined operating rule or AI model. Accordingly, the processor may perform the operations described in the following embodiments, and operations described as being performed by the electronic device or detailed components included in the electronic device in the following embodiments may be viewed as being performed by the processor unless otherwise specifically described.

When a component is referred to in the present disclosure as being “connected” to another component or “connected” to another component, it should be understood that the component may be directly connected to or connected to the other component, but unless there is a specific description to the contrary, it should also be understood that the component may be connected or connected via another component therebetween.

Throughout the present disclosure, unless specifically stated otherwise, “or” is inclusive and not exclusive. Thus, unless clearly described otherwise or the context describes otherwise, “A or B” may refer to “A, B, or both.” In the present disclosure, the phrases “at least one of” or “one or more of” may mean that different combinations of one or more of the listed items may be used, or that only any one of the listed items is required. For example, “at least one of A, B, or C” may include any of the following combinations: A, B, C, A and B, A and C, B and C, or A and B and C.

Combinations of each block of processing flowcharts and the flowcharts may be performed by computer program instructions. Computer program instructions may be installed on a processor of a general computer, a special computer or other programmable data processing equipment, and the instructions executed through the processor of the computer or other programmable data processing equipment may generate an element for performing functions described in block(s) of flowcharts. Computer program instructions may be stored in computer available or computer readable memory that may aim for a computer or other data processing equipment to implement functions in a certain way, and instructions stored in the computer available or computer readable memory may also produce manufacturing items that contain instruction elements for performing the functions described in the block(s) of the flowcharts. It is also possible that computer program instructions are installed on a computer or other programmable data processing equipment, and thus a series of operational steps may be performed on the computer or other programmable data processing device to generate a computer-executable process, and the instructions that cause the computer or other programmable data processing device to perform the steps for performing the functions described in the flowchart block(s) may also provide steps for performing the functions described in the flowchart block(s).

Each block may indicate a part of a module, segment or code including one or more executable instruments for executing a certain logical function(s). It should be noted that in some alternative execution examples, the functions described in the blocks may occur out of order. For example, two blocks that are consecutively shown may actually be performed at the same time, or in reverse order depending on the function.

Embodiments of the present disclosure are described in detail so as for those of skill in the art to easily implement with reference to the accompanying drawings. However, the present disclosure may be implemented in various different forms and is not limited to these embodiments. To clearly describe the present disclosure, a part without concerning to the description is omitted in the drawings, and like reference numerals in the specification denote like elements.

The terms used in the present disclosure will be briefly described, and an embodiment of the present disclosure will be described in detail.

The terms used in the specification are defined in consideration of functions used in the present disclosure, and can be changed according to the intent or conventionally used methods of clients, operators, and users. Accordingly, definitions of the terms should be understood on the basis of the entire description of the present specification.

In the present disclosure, an ‘electronic device’ may mean any device that processes an audio signal. For example, the ‘electronic device’ may perform at least one of an encoding method or decoding method of an audio signal.

In the present disclosure, an ‘audio signal’ may mean a signal including information related to audio. For example, the ‘audio signal’ may be a ‘channel based audio signal’ or an ‘object based audio signal’, or may include both the ‘channel based audio signal’ and the ‘object based audio signal’.

In the present disclosure, the ‘channel based audio signal’ may mean an audio signal for which a channel through which a plurality of audio signals are to be output is predefined according to a channel layout. In the present disclosure, a ‘channel audio signal’ means a ‘channel based audio signal’.

In the present disclosure, a ‘channel layout’ may mean a combination of at least one channel or a spatial arrangement of speakers connected to channels. For example, the channel layout may be an X.Y.Z channel layout. Here, X may be the number of surround channels, Y may be the number of subwoofer channels, and Z may be the number of height channels. Examples of ‘channel layout’ include 1.0.0 channel (mono channel) layout, 2.0.0 channel (stereo channel) layout, 5.1.0 channel layout, 5.1.2 channel layout, 5.1.4 channel layout, 7.1.0 layout, 7.1.2 layout, and 3.1.2 channel layout, but are not limited thereto and may include various channel layouts.

In the present disclosure, ‘rendering’ may mean an operation of converting a plurality of audio signals into an audio signal to be output from one or more speakers.

In the present disclosure, the ‘object based audio signal’ may mean an audio signal rendered such that a speaker for output is determined based on spatial information of an object, rather than a predefined channel layout. In the present disclosure, the ‘object audio signal’ means an ‘object based audio signal’.

In the present disclosure, a ‘multi-channel audio signal’ may mean an audio signal of n channels (n is an integer greater than 2). The ‘multi-channel audio signal’ may mean a channel based audio signal or an object based audio signal or mean an audio signal that includes both the channel based audio signal and the object based audio signal.

In the present disclosure, ‘compression’ may mean an operation of reducing the amount of data of an audio signal and mean an operation of storing or transmitting an audio signal more efficiently. For example, ‘compression’ may be performed by a codec or an encoder, and a decompression operation may be performed by a codec or a decoder.

In the present disclosure, ‘mixing’ means a signal processing operation of generating a new audio signal by adding respective values obtained by multiplying a plurality of audio signals with respective corresponding weights thereof (i.e., mixing the plurality of audio signals).

In the present disclosure, ‘de-mixing’ may mean a signal processing operation of separating a certain audio signal from an audio signal obtained by mixing various audio signals.

In the present disclosure, ‘up-mixing’ may mean a signal processing operation of converting an audio signal such that the number of channels of audio signals output from an electronic device increases compared to the number of channels of audio signals received by the electronic device.

In the present disclosure, ‘down-mixing’ may mean a signal processing operation of converting an audio signal such that the number of channels of audio signals output from an electronic device decreases compared to the number of channels of audio signals received by the electronic device.

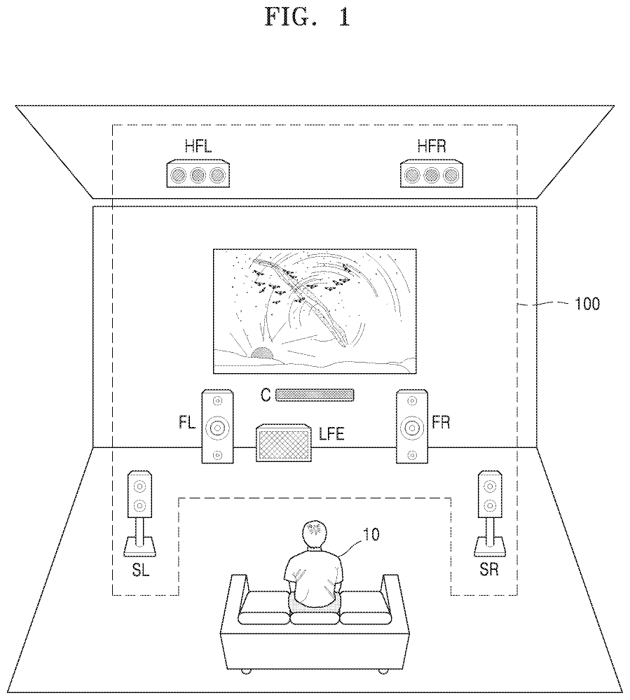

FIG. 1 is a diagram for explaining an electronic device 100 according to an embodiment of the present disclosure.

Referring to FIG. 1, the electronic device 100 may output a channel audio signal according to a channel layout.

The channel layout may include a plurality of channels. For example, a 5.1.2 channel layout may include a total of eight channels, including five surround channels (SL, FL, SR, FR, and C channels), one subwoofer channel (LFE channel), and two height channels (HFL and HFR channels).

The names of a plurality of channels specified by the channel layout may vary, but for convenience of explanation, the names will be unified. A plurality of channels may be named based on spatial locations of the respective channels. For example, in the 5.1.2 channel layout, channels located to the left of the user may be named a surround left (SL) channel and a front left (FL) channel, channels located to the right of the user may be named a surround right (SR) channel and a front right (FR) channel, and a channel located in the center of the user may be named a center (C) channel. A channel located on the upper left of the user may be named a height front left (HFL) channel, and a channel located on the upper right of the user may be named a height front right (HFR) channel. The subwoofer channel forwards a low-frequency signal, and thus may be named a low frequency effect (LFE) channel regardless of a location thereof.

In an embodiment, the electronic device 100 may include a plurality of speakers connected to the plurality of channels. For example, in a 5.1.2 channel layout, the electronic device 100 may include a total of eight speakers, including five speakers connected to the five surround channels, one speaker connected to the one subwoofer channel, and two speakers connected to the height channels.

According to an embodiment, the spatial locations of the plurality of speakers connected to the plurality of channels may be specified according to the channel layout. The spatial locations of the speakers may refer to an angle at which the speaker is located based on a direction in which a user 10 views the electronic device 100. For example, the locations of speakers according to a 5.1.2 channel layout may be predefined as shown in Table 1 below.

TABLE 1

| Channel | Location of speaker |
|---|---|
| SL Channel | Left 110-120° |
| FL Channel | Left 22-30° |
| SR Channel | Right 110-120° |
| FR Channel | Right 22-30° |
| C Channel | 0° |
| HFL Channel | Left 22-30°, Above |
| HFR Channel | Right 22-30°, Above |
| LFE Channel | Anywhere |

In an embodiment, the electronic device 100 may output a channel audio signal by using metadata of the channel audio signal.

The metadata of the channel audio signal may include a variety of information. For example, the metadata of the channel audio signal may include information related to a channel through which the channel audio signal is to be output. For example, the information related to the channel may include the name of each channel and the location of a speaker connected to each channel according to the channel layout. For example, in the case of a 5.1.2 channel layout, information related to the channel of the metadata of the channel audio signal may include at least one of an SL channel, an FL channel, an SR channel, an FR channel, a C channel, an HFL channel, or an HFR channel as a channel name, and the location of the speaker connected to each channel.

In an embodiment, the electronic device 100 may render a channel audio signal by using metadata of the channel audio signal and output the rendered channel audio signal. For example, when the electronic device 100 identifies information related to a channel included in the metadata of the channel audio signal and identifies the channel of the channel audio signal as an SL channel from the information related to the identified channel, the electronic device 100 may determine the SL channel as the channel through which the channel audio signal is to be forwarded. The electronic device 100 may render the channel audio signal such that the channel audio signal is output from a speaker connected to the SL channel. The electronic device 100 may forward the rendered channel audio signal through the SL channel and control a speaker connected to the SL channel to output the rendered channel audio signal.

In an embodiment, the electronic device 100 may output an object audio signal by using metadata of the object audio signal.

The metadata of the object audio signal may include a variety of information. For example, the metadata of the object audio signal may include spatial information of an object corresponding to the object audio signal.

The object corresponding to the object audio signal may mean various objects. For example, the object corresponding to the object audio signal may mean a moving car, a flying bird, or the like. This is an example and not a limitation.

The spatial information of an object may include a variety of information. For example, the spatial information of the object may include the location, distance, direction of movement, movement speed, and the like of the object. This is an example and not a limitation.

In an embodiment, the electronic device 100 may render an object audio signal by using metadata of the object audio signal and output the rendered object audio signal. For example, the electronic device 100 may identify the location of an object from the metadata of the object audio signal. In an embodiment, the electronic device 100 may determine a channel corresponding to the identified location of the object and render the object audio signal such that the object audio signal may be output to a speaker connected to the determined channel. In an embodiment, the electronic device 100 may control the speaker to output the rendered object audio signal.

In an embodiment, when the electronic device 100 is capable of rendering only the channel audio signal and is not capable of rendering the object audio signal, the electronic device 100 may not output an audio signal including the object audio signal. Even when the electronic device 100 is capable of rendering only the channel audio signal, the electronic device 100 may appropriately process the object audio signal to output the audio signal. A method of appropriately processing an object audio signal such that the audio signal may be output even when only the channel audio signal is capable of being rendered is divided into an audio encoding method of an electronic device 200 and an audio decoding method of an electronic device 300 and described below.

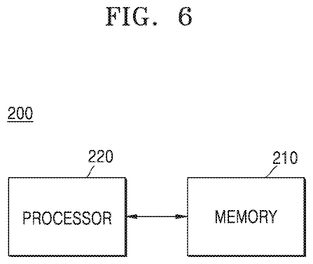

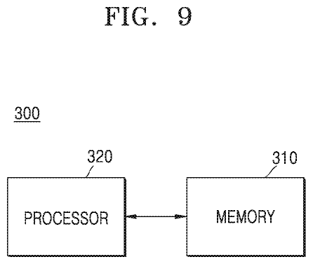

An example embodiment of the electronic device 200 that performs audio encoding is described below with reference to FIG. 6, and the electronic device 300 that performs audio decoding is described below with reference to FIG. 9.

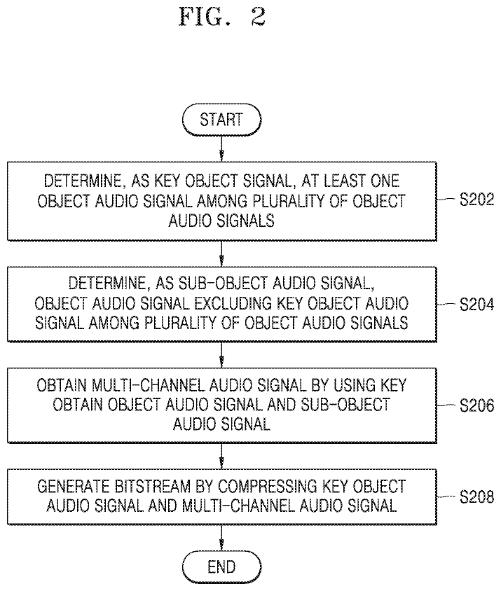

FIG. 2 is a flowchart for explaining an audio encoding method of the electronic device 200 according to an embodiment of the present disclosure.

Referring to FIG. 2, in operation S202, the electronic device 200 may determine, as a key object audio signal, at least one object audio signal among a plurality of object audio signals.

In an embodiment, the electronic device 200 may determine, as a key object audio signal, at least one object audio signal among the plurality of object audio signals based on respective importance levels of the plurality of object audio signals.

In an embodiment, the respective importance levels of the plurality of object audio signals may mean values indicating degrees of importance of the plurality of objects respectively corresponding to the plurality of object audio signals.

In an embodiment, the electronic device 200 may calculate the respective importance levels of the plurality of objects based on spatial information of the plurality of objects respectively corresponding to the plurality of object audio signals.

In an embodiment, the spatial information of the plurality of objects respectively corresponding to the plurality of object audio signals may mean information included in metadata of each of the plurality of object audio signals.

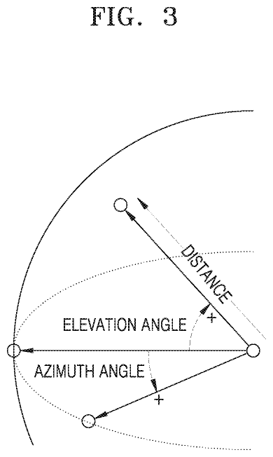

In an embodiment, the spatial information of the plurality of objects respectively corresponding to the plurality of object audio signals may include a variety of information. For example, referring to FIG. 3, the spatial information of each of the plurality of objects may include at least one of a distance, elevation angle, or azimuth angle of the object.

In an embodiment, the spatial information of each of the plurality of objects may include information based on time-series data. For example, the spatial information of the plurality of objects respectively corresponding to the plurality of object signals may include at least one of a moving standard deviation of distances, a moving standard deviation of elevation angles, or a moving standard deviation of azimuth angles, which are calculated from a plurality of distances obtained over time for each of the plurality of objects, a plurality of elevation angles obtained over time, and a plurality of azimuth angles obtained over time for each of the plurality of objects, respectively.

In an embodiment, the electronic device 200 may determine the mobility of each of the plurality of objects based on spatial information of the plurality of objects respectively corresponding to the plurality of object audio signals, and may determine the respective importance levels of the plurality of object audio signals based on the mobility of each of the plurality of objects.

For example, the electronic device 200 may calculate the respective importance levels of the plurality of objects through weighted sum of the moving standard deviation of distances, the moving standard deviation of the elevation angles, and the moving standard deviation of the azimuth angles, which are included in the spatial information of the objects respectively corresponding to the plurality of object signals by using Equation 1 below.

O_{dynamics}=W_{D}*D_{MSD}+W_{E}*E_{MSD}+W_{A}*A_{MSD} [Equation 1]

O_{dynamics} represents the calculated mobility of an object, W_{D}, W_{E}, W_{A} represent a distance weight, elevation weight, and azimuth weight of the object, respectively, and D_{MSD}, E_{MSD}, A_{MSD} represent a moving standard deviation of distances, a moving standard deviation of elevation angles, and a moving standard deviation of azimuth angles, respectively.

In an embodiment, the distance weight, elevation weight, and the azimuth weight of the object may be determined differently depending on the type of object. For example, for an object of which linear movement is important, the distance weight of the object may be determined to have a higher value than the elevation weight and the azimuth weight.

In an embodiment, the electronic device 200 may calculate the mobility of the plurality of objects respectively corresponding to the plurality of object signals by using Equation 1, and may determine the respective importance levels of the plurality of object signals as the mobility of each of the plurality of objects.

In an embodiment, the electronic device 200 may determine the respective importance levels of the plurality of object audio signals based on the mobility of each of the plurality of objects and the respective volumes of the plurality of object audio signals. For example, the electronic device 200 may calculate a weighted average of the mobility of each of the plurality of object audio signals and the volume of each of the plurality of object audio signals by using Equation 2 below and determine the respective importance levels of the plurality of objects.

O_{priority}=α*O_{dynamics}+(1−α)*O_{loudness} [Equation 2]

O_{priority} may represent an importance level of an object, O_{loudness} may represent a volume of an object audio signal, and α may represent a weight greater than or equal to 0 and less than or equal to 1.

In an embodiment, α may be determined differently depending on a degree of importance of the mobility or volume of the object. For example, for an object of which mobility is important, α may be determined to have a value greater than 0.5.

In an embodiment, the electronic device 200 may determine, as key object audio signals, a preset number of object audio signals having a high importance level among the respective importance levels of a plurality of object audio signals. For example, among the plurality of object audio signals, P object audio signals having a high importance level calculated using Equation 2 may be determined as key object audio signals. For example, among 122 object audio signals, 8 object audio signals having a high importance level calculated using Equation 2 may be determined as key object audio signals.

Referring back to FIG. 2, in operation S204, the electronic device 200 may determine, as a sub-object audio signal, an object audio signal excluding the key object audio signal among the plurality of object audio signals.

In an embodiment, the electronic device 200 may generate a cluster of audio signals by using the determined key object audio signal and one or more sub-object audio signals. For example, a pair of a key object audio signal and a sub-object audio signal in which a difference between the mobility of each of a plurality of key object audio signals and the mobility of each of the sub-object audio signals is less than or equal to a preset threshold value may be determined, and a cluster of audio signals may be generated by combining the determined pairs of key object audio signals and sub-object audio signals.

In operation S206, the electronic device 200 may obtain a multi-channel audio signal by using the key object audio signal and the sub-object audio signal.

In an embodiment, the multi-channel audio signal obtained by rendering the key object audio signal and the sub-object audio signal may refer to a channel based audio signal. For example, the electronic device 200 may render and convert the key object audio signal and the sub-object audio signal into channel audio signals, respectively, and mix the converted channel audio signals to obtain the multi-channel audio signal. In an embodiment, the electronic device 200 may record, in metadata, information related to channels, including the name of each channel according to the channel layout and the location of a speaker connected to each channel.

In an embodiment, the electronic device 200 may obtain a bed channel audio signal, which is a channel based audio signal. For example, the bed channel audio signal may refer to a channel based audio signal that includes background sounds and sound effects.

In an embodiment, the electronic device 200 may obtain a multi-channel audio signal by using a bed channel audio signal, a key object audio signal, and a sub-object audio signal.

In an embodiment, the electronic device 200 may render the bed channel audio signal, the key object audio signals, and the sub-object audio signal. For example, the electronic device 200 may render and convert the key object audio signal and the sub-object audio signal into channel audio signals, respectively.

In an embodiment, the electronic device 200 may obtain a multi-channel audio signal by mixing the rendered bed channel audio signal, the rendered key object audio signal, and the rendered sub-object audio signal. For example, the electronic device 200 may obtain the multi-channel audio signal, which is a channel audio signal, by mixing the rendered bed channel audio signal, the rendered key object audio signal, and the rendered sub-object audio signal.

In operation S208, the electronic device 200 may generate a bitstream by compressing the key object audio signal and the multi-channel audio signal. In an embodiment, the electronic device 200 may compress the key object audio signal and the multi-channel audio signal by using a codec.

In an embodiment, when an audio signal needs to be compressed significantly, the electronic device 200 may generate a bitstream by compressing the key object audio signal and the multi-channel audio signal by using at least one of OPUS or advanced audio coding (AAC), which is a codec that performs lossy compression. Lossy compression may refer to a signal processing operation in which some of data is lost during a compression process.

In an embodiment, when an audio signal needs to be compressed without loss, the electronic device 200 may generate a bitstream by compressing the key object audio signal and the multi-channel audio signal by using free lossless audio codec (FLAC), which is a codec that performs lossless compression.

In an embodiment, when a multi-channel audio signal is compressed by a codec that performs lossy compression, some of the audio signal may be lost due to lossy compression. In this case, to reduce loss of the audio signal, pre-processing may be performed on the key object audio signal in a stage of obtaining the multi-channel audio signal.

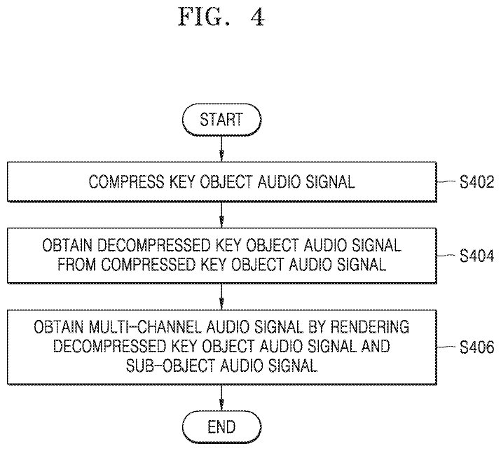

FIG. 4 is a flowchart for explaining a method of pre-processing a key object audio signal according to an embodiment of the present disclosure.

Referring to FIG. 4, in operation S402, the electronic device 200 may compress a key object audio signal. For example, the electronic device 200 may compress the key object audio signal by using the same method as the method of compressing the multi-channel audio signal in operation S208. In an embodiment, when compressing the multi-channel audio signal by using an audio codec that performs lossy compression in operation S208, for example, an OPUS codec, the key object audio signal may be compressed using the OPUS codec in operation S402.

In operation S404, the electronic device 200 may obtain a decompressed key object audio signal from the compressed key object audio signal. For example, the electronic device 200 may decompress the compressed key object audio signal by using an OPUS codec used to compress the key object audio signal.

In operation S406, the electronic device 200 may render the decompressed key object audio signal and sub-object audio signal to obtain the multi-channel audio signal. In an embodiment, the decompressed key object audio signal is obtained by performing lossy compression and subsequent decompression, and thus may refer to an audio signal in which a portion of the original key object audio signal before compression is lost.

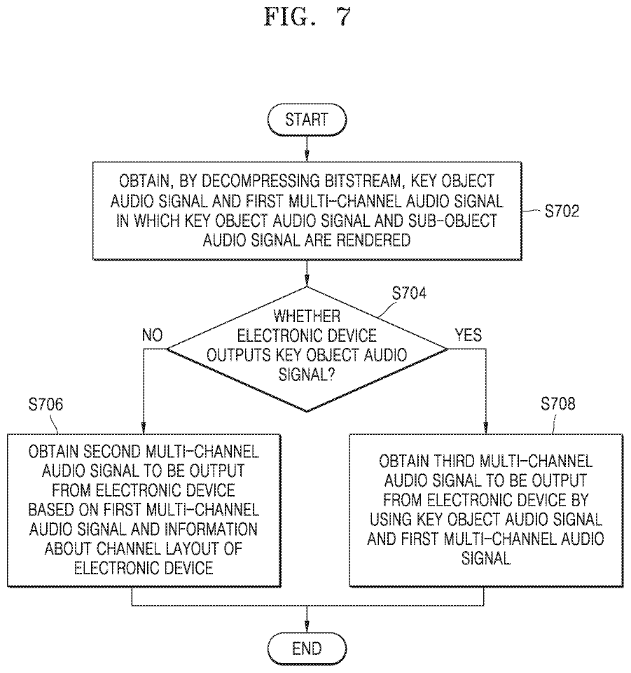

In an embodiment, the electronic device 200 may transmit the generated bitstream to the electronic device 300 that performs audio decoding. An audio decoding method performed in the electronic device 300 will be described below with reference to FIG. 7.

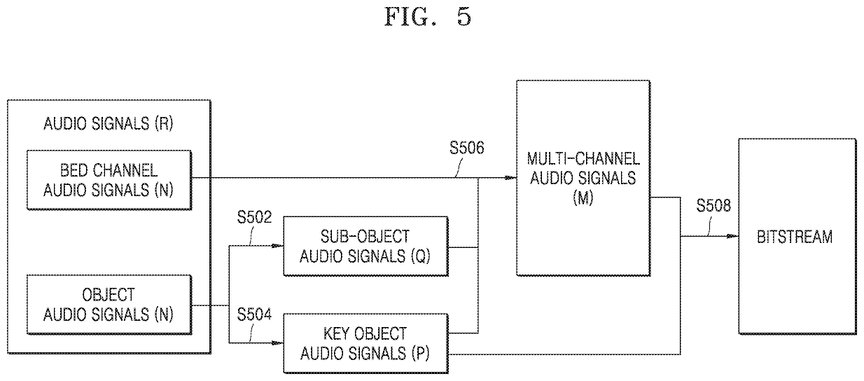

FIG. 5 is a block diagram for explaining an audio encoding method according to an embodiment of the present disclosure. Hereinafter, the description of the operations described above is omitted for brevity.

Referring to FIG. 5, R audio signals may include N bed channel audio signals and L object audio signals. For example, 128 audio signals may include 6 bed channel audio signals and 122 object audio signals.

In operation S502, the electronic device 200 may determine P key object audio signals among L object audio signals. For example, the electronic device 200 may determine 8 key object audio signals among 122 object audio signals.

In operation S502, the electronic device 200 may determine Q sub-object audio signals excluding P key object audio signals among L object audio signals. For example, the electronic device 200 may determine 114 sub-object audio signals excluding 8 key object audio signals among 122 object audio signals.

In operation S506, the electronic device 200 may obtain the multi-channel audio signal including M channels by using N bed channel audio signals, Q sub-object audio signals, and P key object audio signals. For example, the electronic device 200 may render six bed channel audio signals, 114 sub-object audio signals, and 8 key object audio signals. The multi-channel audio signal including 8 channels may be obtained by mixing the rendered 6 bed channel audio signals, the rendered 114 sub-object audio signals, and the rendered 8 key object audio signals.

In operation S508, the electronic device 200 may generate a bitstream by compressing the multi-channel audio signal including P key object audio signals and M channels. For example, the electronic device 200 may obtain the bitstream by compressing the multi-channel audio signal including 8 key object audio signals and 8 channels.

According to the embodiment described above, when the importance levels are calculated to determine a key object audio signal and only the determined key object audio signal is compressed, the sound quality of the output audio signal may be improved by reducing a compression error when a third multi-channel audio signal to be described with reference to FIG. 7 is obtained.

FIG. 6 is a block diagram for explaining an electronic device that performs audio encoding according to an embodiment of the present disclosure.

Referring to FIG. 6, the electronic device 200 may include memory 210 and at least one processor 220 (hereafter also referred to as “the processor 220”). The electronic device 200 may be implemented as a device capable of audio processing, such as a server, TV, mobile phone, tablet PC, or laptop.

Although the memory 210 and the processor 220 are illustrated separately in FIG. 6, the memory 210 and the processor 220 may be implemented through a single hardware module (e.g., chip).

The memory 210 may store one or more instructions for processing an audio signal. In an embodiment, the memory 210 may store an audio signal and metadata of the audio signal. For example, the memory 210 may store a plurality of object audio signals and metadata of each of the plurality of object audio signals. For example, the memory 210 may store a bed channel audio signal and metadata of the bed channel audio signal.

The processor 220 configured to execute one or more instructions stored in the memory 210 may include a plurality of processors. In this case, the processor 220 may be implemented as a combination of dedicated processors or may be implemented through a combination of a plurality of general-purpose processors such as a central processing unit (CPU) or graphic processing unit (GPU) and software.

In an embodiment, the processor 220 may determine, as a key object audio signal, at least one object audio signal among a plurality of object audio signals, determine, as a sub-object audio signal, an object audio signal excluding the key object audio signal among the plurality of object audio signals, obtain a multi-channel audio signal by using the key object audio signal and the sub-object audio signal, and generate a bitstream by compressing the key object audio signal and the multi-channel audio signal.

In an embodiment, the processor 220 may render the key object audio signal and the sub-object audio signal. In an embodiment, the processor 220 may compress the key object audio signal, obtain a decompressed key object audio signal from the compressed key object audio signal, and render the decompressed key object audio signal and sub-object audio signal to obtain a multi-channel audio signal.

In an embodiment, the processor 220 may compress a key object audio signal by using an encoder used to compress a multi-channel audio signal.

In an embodiment, metadata of each of the plurality of object audio signals includes spatial information of each object corresponding to the plurality of object audio signals, and the spatial information may include at least one of information about a distance, information about an elevation angle, or information about an azimuth angle of each object.

In an embodiment, the processor 220 may determine the mobility of each of the plurality of objects based on spatial information of each of the plurality of objects corresponding to each of the plurality of object audio signals, determine the respective importance levels of the plurality of object audio signals based on the mobility of each of the plurality of objects and the volume of each of the plurality of object audio signals, and determine, as key object audio signals, a preset number of object audio signals having a high importance level among the respective importance levels.

FIG. 7 is a flowchart for explaining an audio decoding method of the electronic device 300 according to an embodiment of the present disclosure.

Referring to FIG. 7, in operation S702, the electronic device 300 may decompress a bitstream to obtain a key object audio signal and obtain a first multi-channel audio signal in which the key object audio signal and the sub-object audio signal are rendered.

In an embodiment, the bitstream may be data in which an audio signal is compressed, and the bitstream may mean data received from the electronic device 200 or stored in memory 310 of the electronic device 300 of FIG. 9.

In an embodiment, the key object audio signal may be the key object audio signal determined in operation S204.

In an embodiment, the first multi-channel audio signal may be the multi-channel audio signal obtained in operation S206. For example, the first multi-channel audio signal may be an audio signal converted into a channel audio signal by rendering the key object audio signal and the sub-object audio signal.

In operation S704, the electronic device 300 may determine whether the electronic device 300 is capable of outputting the key object audio signal. For example, when the electronic device 300 is not capable of rendering object audio, the electronic device 300 may determine that the electronic device 300 is not capable of outputting the key object audio signal. According to an embodiment, when the electronic device 300 is capable of rendering object audio, the electronic device 300 may determine that the electronic device 300 is capable of outputting the key object audio signal.

When it is determined that the electronic device 300 is not capable of outputting the key object audio signal, a second multi-channel audio signal that is to be output from the electronic device 300 may be obtained based on the first multi-channel audio signal and information about the channel layout of the electronic device 300 in operation S706.

In an embodiment, the electronic device 300 may obtain the second multi-channel audio signal by converting the first multi-channel audio signal in correspondence with the channel layout of the electronic device 300. For example, when the first multi-channel audio signal is a channel audio signal that is to be output in a 5.1.2 channel layout, and the channel layout of the electronic device 300 is a 5.1 channel layout, the electronic device 300 may down-mix the first multi-channel audio signal to obtain a second multi-channel audio signal that is a channel audio signal that is to be output in a 5.1 channel layout.

When it is determined that the electronic device 300 is capable of being output a key object audio signal, in operation S708, the electronic device 300 may obtain a third multi-channel audio signal that is to be output from the electronic device 300 by using the key object audio signal and the first multi-channel audio signal.

In an embodiment, the electronic device 300 may render the key object audio signal and the first multi-channel audio signal to obtain the third multi-channel audio signal that is to be output from the electronic device 300. For example, the electronic device 300 may render the key object audio signal such that the key object audio signal may be output from a speaker. In an embodiment, the electronic device 300 may render the first multi-channel audio signal to be mixed with the rendered key object audio signal.

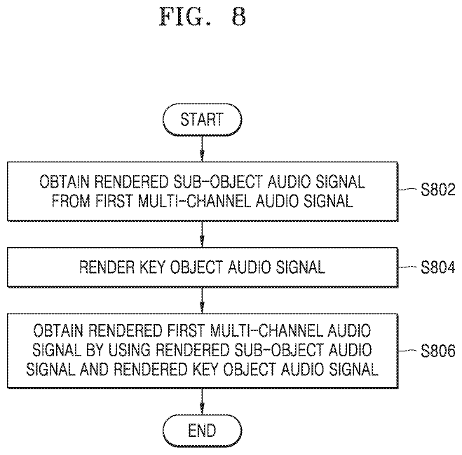

FIG. 8 is a flowchart for explaining a method of rendering a first multi-channel audio signal according to an embodiment of the present disclosure.

Referring to FIG. 8, in operation S802, the electronic device 300 may obtain the rendered sub-object audio signal from the first multi-channel audio signal. For example, the electronic device 300 may de-mix the first multi-channel audio signal to obtain the rendered sub-object audio signal. The rendered sub-object audio signal obtained by de-mixing the first multi-channel audio signal may be a channel audio signal. For example, the electronic device 300 may simultaneously obtain the rendered bed channel audio signal and the rendered key object audio signal by de-mixing the first multi-channel audio signal in addition to the rendered sub-object audio signal by de-mixing the first multi-channel audio signal. The rendered bed channel audio signal, the rendered key object audio signal, and the rendered sub-object audio signal obtained by de-mixing the first multi-channel audio signal may be channel audio signals.

In operation S804, the electronic device 300 may render the key object audio signal obtained in operation S702. For example, the electronic device 300 may render and convert the key object audio signal obtained in operation S702 into a channel audio signal.

In operation S806, the electronic device 300 may obtain the rendered first multi-channel audio signal by using the rendered sub-object audio signal and the rendered key object audio signal. For example, the electronic device 300 may obtain the rendered first multi-channel audio signal, which is a channel audio signal, by mixing the rendered sub-object audio signal and the rendered key object audio signal.

In an embodiment, the electronic device 300 may obtain a third multi-channel audio signal by using the rendered key object audio signal and the rendered first multi-channel audio signal. For example, the electronic device 300 may obtain the third multi-channel audio signal by mixing the rendered key object audio signal and the rendered first multi-channel audio signal. For example, the third multi-channel audio signal may mean an audio signal in which the object audio signal is rendered to be output from a speaker.

FIG. 9 is a block diagram for explaining an electronic device that performs audio decoding according to an embodiment of the present disclosure.

Referring to FIG. 9, the electronic device 300 may include the memory 310 and at least one processor 320 (hereafter also referred to as “the processor 320”). The electronic device 300 may be implemented as a device capable of audio processing, such as a server, TV, mobile phone, tablet PC, or laptop.

Although the memory 310 and the processor 320 are illustrated separately in FIG. 9, the memory 310 and the processor 320 may be implemented through a single hardware module (e.g., chip).

The memory 310 may store one or more instructions for processing an audio signal. In an embodiment, the memory 310 may store an audio signal and metadata of the audio signal. For example, the memory 310 may store a plurality of object audio signals and metadata of each of the plurality of object audio signals. For example, the memory 210 may store a bed channel audio signal and metadata of the bed channel audio signal.

The processor 320 configured to execute one or more instructions stored in the memory 310 may include a plurality of processors. In this case, the processor may be implemented as a combination of dedicated processors or may be implemented through a combination of a plurality of general-purpose processors such as a central processing unit (CPU) or graphic processing unit (GPU) and software.

In an embodiment, the processor 320 may decompress a bitstream to obtain a key object audio signal and a first multi-channel audio signal in which the key object audio signal and the sub-object audio signal are rendered.

In an embodiment, when the processor 320 determines that the electronic device 300 is not capable of outputting the key object audio signal, the processor 320 may obtain a second multi-channel audio signal that is to be output from the electronic device 300 based on the first multi-channel audio signal and information about the channel layout of the electronic device 300.

In an embodiment, when the processor 320 determines that a decoding device 300 is capable of outputting a key object audio signal, the processor 320 may obtain a third multi-channel audio signal that is to be output from the electronic device 300 by using the key object audio signal and the first multi-channel audio signal.

In an embodiment, the processor 320 may obtain the second multi-channel audio signal by converting the first multi-channel audio signal in correspondence with the channel layout.

In an embodiment, the processor 320 may render the key object audio signal and the first multi-channel audio signal.

In an embodiment, the processor 320 may obtain a third multi-channel audio signal by using the rendered key object audio signal and the rendered first multi-channel audio signal.

In an embodiment, the processor 320 may obtain the rendered sub-object audio signal from the first multi-channel audio signal.

In an embodiment, the processor 320 may render the key object audio signal.

In an embodiment, the processor 320 may obtain the rendered first multi-channel audio signal by using the rendered sub-object audio signal and the rendered key object audio signal.

The audio processing method of the electronic device 200 and the audio processing method of the electronic device 300, which are described above, may be implemented in separate devices or may be implemented in one device. Hereinafter, a method of controlling the electronic device 200, in which the audio processing method of the electronic device 200 and the audio processing method of the electronic device 300 are implemented in one device, will be described.

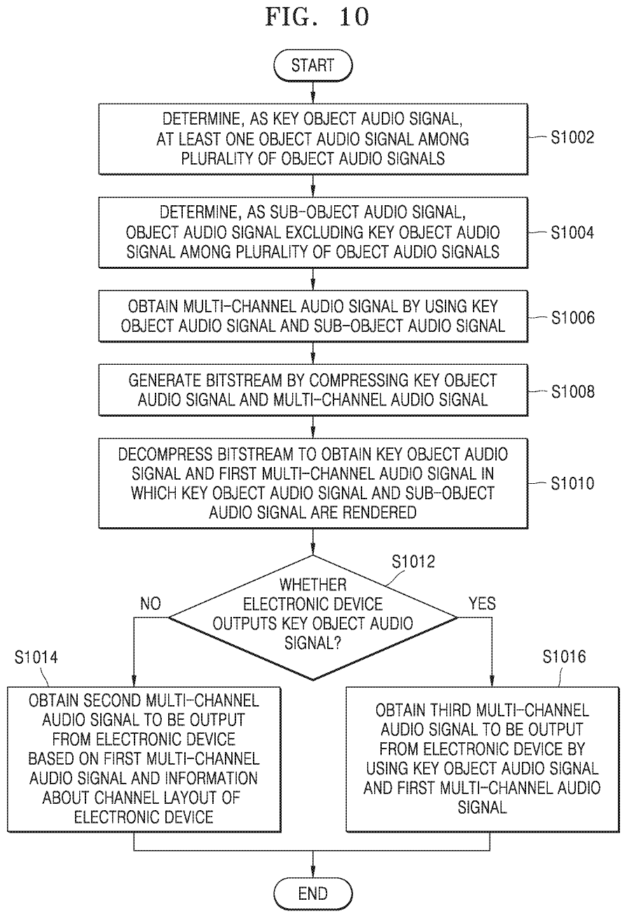

FIG. 10 is a flowchart for explaining an audio processing method of the electronic device 100 according to an embodiment of the present disclosure. Hereinafter, the description of the operations described above is omitted for brevity.

Referring to FIG. 10, in operation S1002, the electronic device 100 may determine, as a key object audio signal, at least one object audio signal among a plurality of object audio signals.

In an embodiment, the electronic device 100 may determine, as a key object audio signal, at least one object audio signal among the plurality of object audio signals based on the respective importance levels of the plurality of object audio signals.

In operation S1004, the electronic device 100 may determine, as a sub-object audio signal, an object audio signal excluding the key object audio signal among the plurality of object audio signals.

In operation S1006, the electronic device 100 may obtain a multi-channel audio signal by using the key object audio signal and the sub-object audio signal.

In operation S1008, the electronic device 100 may generate a bitstream by compressing the key object audio signal and the multi-channel audio signal.

In operation S1010, the electronic device 100 may decompress a bitstream to obtain a key object audio signal and a first multi-channel audio signal in which the key object audio signal and the sub-object audio signal are rendered.

In operation S1012, the electronic device 100 may determine whether the electronic device 100 is capable of outputting the key object audio signal.

When it is determined that the electronic device 100 is not capable of outputting a key object audio signal, in operation S1014, the electronic device 100 may obtain a second multi-channel audio signal that is to be output from the electronic device 100 based on the first multi-channel audio signal and information about the channel layout of the electronic device.

When it is determined that the electronic device 100 is capable of being output a key object audio signal, in operation S1016, the electronic device 100 may obtain a third multi-channel audio signal that is to be output from the electronic device 100 by using the key object audio signal and the first multi-channel audio signal.

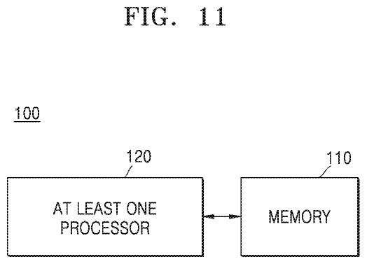

FIG. 11 is a schematic block diagram of the electronic device 100 that performs an audio processing method according to an embodiment of the present disclosure.

Referring to FIG. 11, the electronic device 100 may include memory 110 and at least one processor 120. The memory 110 and at least one processor 120 included in the electronic device 100 are the same components as the memories 210 and 310 and the processors 220 and 320 described above, and repeated descriptions are omitted for brevity.

In an embodiment, the at least one processor 120 may determine, as a key object audio signal, at least one object audio signal among a plurality of object audio signals, determine, as a sub-object audio signal, an object audio signal excluding the key object audio signal among the plurality of object audio signals, obtain a multi-channel audio signal by using the key object audio signal and the sub-object audio signal, and generate a bitstream by compressing the key object audio signal and the multi-channel audio signal.

In an embodiment, the at least one processor 120 may render the key object audio signal and the sub-object audio signal to obtain the multi-channel audio signal. In an embodiment, the at least one processor 120 may compress the key object audio signal, obtain a decompressed key object audio signal from the compressed key object audio signal, and render the decompressed key object audio signal and sub-object audio signal to obtain a multi-channel audio signal.

In an embodiment, the at least one processor 120 may compress a key object audio signal by using an encoder used to compress a multi-channel audio signal.

In an embodiment, metadata of each of the plurality of object audio signals includes spatial information of objects respectively corresponding to the plurality of object audio signals, and the spatial information may include at least one of information about a distance, information about an elevation angle, or information about an azimuth angle of each object.

In an embodiment, the at least one processor 120 may determine the mobility of each of the plurality of objects based on spatial information of the plurality of objects respectively corresponding to the plurality of object audio signals, determine the respective importance levels of the plurality of object audio signals based on the mobility of each of the plurality of objects and the volume of each of the plurality of object audio signals, and determine, as key object audio signals, a preset number of object audio signals having a high importance level among the respective importance levels.

In an embodiment, the at least one processor 120 may decompress a bitstream to obtain a key object audio signal and a first multi-channel audio signal in which the key object audio signal and the sub-object audio signal are rendered, and in this case, when determining that the electronic device 100 is not capable of outputting the key object audio signal, the at least one processor 120 may obtain a second multi-channel audio signal that is to be output from the electronic device 100 based on the first multi-channel audio signal and information about a channel layout of the electronic device 100, and when determining that the electronic device 100 is capable of outputting the key object audio signal, the at least one processor 120 may obtain a third multi-channel audio signal that is to be output from the electronic device 100 by using the key object audio signal and the first multi-channel audio signal.

In an embodiment, the at least one processor 120 may obtain the second multi-channel audio signal by converting the first multi-channel audio signal in correspondence with the channel layout.

In an embodiment, the at least one processor 120 may render the key object audio signal and the first multi-channel audio signal and obtain the third multi-channel audio signal by using the rendered key object audio signal and the rendered first multi-channel audio signal.

In an embodiment, the at least one processor 120 may obtain a rendered sub-object audio signal from a first multi-channel audio signal, render a key object audio signal, and obtain the rendered first multi-channel audio signal by using the rendered sub-object audio signal and the rendered key object audio signal.

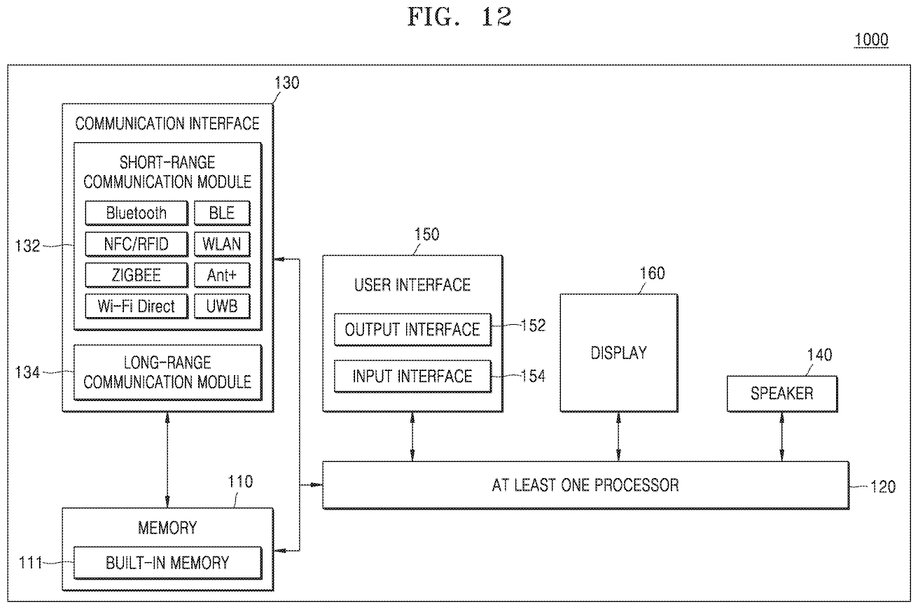

FIG. 12 is a detailed block diagram of an electronic device according to an embodiment of the present disclosure.

Referring to FIG. 12, an electronic device 1000 may, for example, constitute all or part of the electronic device 200 illustrated in FIG. 6, constitute all or part of the electronic device 300 illustrated in FIG. 9, or constitute all or part of the electronic device 100 illustrated in FIG. 11. Referring to FIG. 12, the electronic device 1000 may include the memory 110, the at least one processor 120, a communication interface 130, a speaker 140, a user interface 150, and a display 160. However, not all of the illustrated components are required, and the electronic device 1000 may be implemented with more or fewer components than the illustrated components. The memory 110 and the at least one processor 120 are the same as in FIG. 11, and thus a repeated description is omitted.

In an embodiment, the memory 110 may include built-in memory 111. The built-in memory 111 may include, for example, at least one of volatile memory (e.g., dynamic RAM (DRAM), static RAM (SRAM), or synchronous dynamic RAM (SDRAM)) or non-volatile memory (e.g., one time programmable ROM (OTPROM), programmable ROM (PROM), erasable and programmable ROM (EPROM), electrically erasable and programmable ROM (EEPROM), mask ROM, flash ROM, NAND flash memory, or NOR flash memory).

In an embodiment, the at least one processor 120 may include one or more processors. In this case, the one or more processors may include a general-purpose processor such as a CPU, an AP, and a digital signal processor (DSP), a graphics-only processor such as a GPU and a vision processing unit (VPU), or an artificial intelligence-only processor such as an NPU. When the one or more processors are AI-dedicated processors, the AI-dedicated processors may be designed with a hardware structure specialized for processing a certain AI model.

The communication interface 130 may transmit and receive data with a base station connected to the electronic device 1000 through a network or other device capable of communicating with the electronic device 1000. For example, the communication interface 130 may include a short-range communication module 132 and a long-range communication module 134. The short-range communication module (or short-range wireless communication interface) may be used to transmit and receive data with other devices capable of communication. For example, the short-range communication module 132 may include, but is not limited to, a Bluetooth communication module, a Bluetooth low energy (BLE) communication module, a near field communication interface, a WLAN (Wi-Fi) communication module, a Zigbee communication module, an infrared data association (IrDA) communication module, a Wi-Fi direct (WFD) communication module, an ultra wideband (UWB) communication module, and an Ant+ communication module. The long-range communication module 134 may include the Internet, a computer network (e.g., LAN or WAN), and a mobile communication module. The mobile communication module transmits and receives a wireless signal with at least one of a base station, an external terminal, and a server on a mobile communication network. Here, the wireless signal may include various forms of data such as a voice call signal, video call signal, or text/multimedia message transmission and reception. The mobile communication module may include, but is not limited to, a 3G module, a 4G module, an LTE module, a 5G module, a 6G module, an NB-IoT module, and an LTE-M module.

In an embodiment, the communication interface 130 may receive a plurality of object audio signals.

In an embodiment, the communication interface 130 may compress an audio signal and transmit the generated bitstream to another electronic device.

In an embodiment, the communication interface 130 may receive a bitstream transmitted from another electronic device.

The speaker 140 outputs sound. The speaker 140 may output various audio signals. In an embodiment, the speaker 140 may output a channel audio signal and an object audio signal rendered to be output from the speaker 140, separately or simultaneously.

The user interface 150 may include an input interface 154 configured to receive user input and an output interface 152 configured to output information. The output interface 152 is for outputting a video signal or an audio signal. When the display 160 and a touchpad constitute a touch screen with a layer structure, the display 160 may be used as the input interface 154 in addition to the output interface 152. In an embodiment, the output interface 152 may be connected to the speaker 140 to output an audio signal.

The user interface 150 may include, for example, a high-definition multimedia interface (HDMI) and a universal serial bus (USB). Additionally or alternatively, the user interface 150 may include, for example, a mobile high-definition link (MHL) interface, a secure digital (SD) card/multi-media card (MMC) interface, or an infrared data association (IrDA) standard interface.

The display 160 may include a display panel and a controller configured to control the display panel, and the display 160 may represent a display built in the electronic device 1000. The display panel may be implemented in various forms of displays such as liquid crystal display (LCD), an organic light emitting diode (OLED) display, an active-matrix organic light-emitting diode (AM-OLED), and a plasma display panel (PDP). The display panel may be implemented to be flexible, transparent or wearable. The display 160 may be combined with a touch panel and provided as a touch screen. For example, the touch screen may include an integrated module in which a display panel and a touch panel are combined in a stacked structure.

A method according to an embodiment of the disclosure may be implemented in the form of program commands that may be executed through various computer devices and recorded in a computer-readable medium. The computer-readable medium may include a program command, a data file, and a data structure alone or in combination. The program commands recorded in the medium may be those specifically designed and configured for the disclosure or may be known and available to those of skill in the art of computer software. Examples of a computer readable recording medium include magnetic media such as hard disks, floppy disks and magnetic tapes, optical media such as CD-ROMs and DVDs, magneto-optical media such as floptical disks, or hardware devices such as ROMs, RAMs and flash memories, which are specially configured to store and execute program commands. Examples of the program commands include a machine language code generated by a compiler and a high-level language code executable by a computer using an interpreter and the like.

Some embodiment of the disclosure may also be implemented in the form of a recording medium containing computer-executable instructions, such as program modules executed by a computer. Computer-readable media may be any available media that are to be accessed by a computer, and includes both volatile and nonvolatile media, removable and non-removable media. Computer-readable media may include both computer storage media and communication media. Computer storage media includes both volatile and nonvolatile, removable and non-removable media implemented in any method or technology for storage of information such as computer-readable instructions, data structures, program modules or other data. Communication media typically include computer readable instructions, data structures, program modules, or other data in a modulated data signal such as a carrier wave, or other transport mechanism, and includes any information delivery media. Some embodiments of the disclosure may also be implemented as a computer program or computer program product including computer-executable instructions, such as a computer program executed by a computer.

The device-readable storage medium may be provided in the form of a non-transitory storage medium. Here, the term ‘non-transitory storage medium’ simply means a tangible device that does not contain signals (e.g. electromagnetic waves), and the term does not distinguish between cases in which data is stored semi-permanently or temporarily on a storage medium. For example, the ‘non-transitory storage medium’ may include a buffer in which data is temporarily stored.

According to an embodiment of the disclosure, the method according to the various embodiments disclosed herein may be included in a computer program product and provided. The computer program product may be traded between a seller and a buyer as a product. The computer program product may be distributed in the form of a storage medium (e.g. compact disk read only memory (CD-ROM)) that is to be read on a device, or may be distributed (e.g., downloaded or uploaded) directly or online through an application store or between two user devices (e.g., smartphones). In the case of online distribution, at least some of the computer program products (e.g., downloadable application) may be at least temporarily stored in a device-readable storage medium such as a server of a manufacturer, a server of an application server, or memory of a relay server, or may be temporarily generated.

In an embodiment, the audio processing method may include rendering the key object audio signal and the sub-object audio signal. In an embodiment, the audio processing method may include compressing the key object audio signal, obtaining a decompressed key object audio signal from the compressed key object audio signal, and rendering the decompressed key object audio signal and sub-object audio signal to obtain a multi-channel audio signal.

In an embodiment, a bed channel audio signal, which is a channel based audio signal, may be obtained. In an embodiment, the audio processing method may include rendering the bed channel audio signal, the key object audio signal, and the sub-object audio signal. In an embodiment, the audio processing method may include obtaining a multi-channel audio signal by mixing the rendered bed channel audio signal, the rendered key object audio signal, and the rendered sub-object audio signal.

In an embodiment, the audio processing method may include compressing a key object audio signal by using an encoder used to compress a multi-channel audio signal.

In an embodiment, metadata of each of the plurality of object audio signals includes spatial information of each object corresponding to the plurality of object audio signals, and the spatial information may include at least one of information about a distance, information about an elevation angle, or information about an azimuth angle of each object.

In an embodiment, the audio processing method may include determining the mobility of each of the plurality of objects based on spatial information of each of the plurality of objects corresponding to each of the plurality of object audio signals, determining the respective importance levels of the plurality of object audio signals based on the mobility of each of the plurality of objects and the volume of each of the plurality of object audio signals, and determining, as key object audio signals, a preset number of object audio signals having a high importance level among the respective importance levels.

In an embodiment, the audio processing method may include decompressing a bitstream to obtain a key object audio signal and a first multi-channel audio signal in which the key object audio signal and the sub-object audio signal are rendered, when determining that the electronic device is not capable of outputting the key object audio signal, obtaining a second multi-channel audio signal that is to be output from the electronic device based on the first multi-channel audio signal and information about a channel layout of the electronic device, and when determining that the electronic device is capable of outputting the key object audio signal, obtaining a third multi-channel audio signal that is to be output from the electronic device by using the key object audio signal and the first multi-channel audio signal.

In an embodiment, the audio processing method may include obtaining the second multi-channel audio signal by converting the first multi-channel audio signal in correspondence with the channel layout.

In an embodiment, the audio processing method may include rendering the key object audio signal and the first multi-channel audio signal and obtaining the third multi-channel audio signal by using the rendered key object audio signal and the rendered first multi-channel audio signal.

In an embodiment, the audio processing method may include obtaining a rendered sub-object audio signal from a first multi-channel audio signal, rendering a key object audio signal, and obtaining the rendered first multi-channel audio signal by using the rendered sub-object audio signal and the rendered key object audio signal.

What is claimed is:

1. An audio processing method of an electronic device, the audio processing method comprising:
determining, as a key object audio signal, at least one object audio signal among a plurality of object audio signals;
determining, as a sub-object audio signal, an object audio signal, other than the key object audio signal, among the plurality of object audio signals;
obtaining a multi-channel audio signal by using the key object audio signal and the sub-object audio signal; and
generating a bitstream by compressing the key object audio signal and the multi-channel audio signal.

2. The audio processing method of claim 1, further comprising obtaining a bed channel audio signal which is a channel based audio signal,
wherein the obtaining of the multi-channel audio signal comprises:
rendering each of the bed channel audio signal, the key object audio signal, and the sub-object audio signal; and
obtaining the multi-channel audio signal by mixing the rendered bed channel audio signal, the rendered key object audio signal, and the rendered sub-object audio signal.

3. The audio processing method of claim 2, wherein the rendering the key object audio signal comprises:
compressing the key object audio signal;
obtaining a decompressed key object audio signal from the compressed key object audio signal; and
obtaining the multi-channel audio signal by rendering the decompressed key object audio signal and the sub-object audio signal.

4. The audio processing method of claim 3, wherein the compressing the key object audio signal comprises compressing the key object audio signal by using an encoder that is used to compress the multi-channel audio signal.

5. The audio processing method of claim 1, wherein metadata of each of the plurality of object audio signals comprises spatial information of objects respectively corresponding to the plurality of object audio signals, and
wherein the spatial information comprises at least one of information about a distance of each object, information about an elevation angle, or information about an azimuth angle.

6. The audio processing method of claim 1, wherein the determining, as the key object audio signal, the at least one object audio signal comprises:
determining mobility of each of a plurality of objects based on spatial information of each of the plurality of objects respectively corresponding to the plurality of object audio signals;
determining respective importance levels of the plurality of object audio signals based on the mobility of each of the plurality of objects and respective volumes of the plurality of object audio signals; and
determining, as key object audio signals, a preset number of object audio signals having a high importance level among the importance levels.

7. An audio processing method of an electronic device, the audio processing method comprising:
decompressing a bitstream to obtain a key object audio signal and a first multi-channel audio signal in which the key object audio signal and a sub-object audio signal are rendered;
based on determining the electronic device is not capable of outputting the key object audio signal, obtaining a second multi-channel audio signal that is to be output from the electronic device based on the first multi-channel audio signal and information about a channel layout of the electronic device; and
based on determining the electronic device is capable of outputting the key object audio signal, obtaining a third multi-channel audio signal that is to be output from the electronic device by using the key object audio signal and the first multi-channel audio signal.

8. The audio processing method of claim 7, wherein the obtaining the second multi-channel audio signal comprises converting the first multi-channel audio signal based on the channel layout to obtain the second multi-channel audio signal.

9. The audio processing method of claim 8, wherein the obtaining the third multi-channel audio signal comprises:
rendering each of the key object audio signal and the first multi-channel audio signal; and
obtaining the third multi-channel audio signal by using the rendered key object audio signal and the rendered first multi-channel audio signal.

10. The audio processing method of claim 9, wherein the rendering the first multi-channel audio signal comprises:
obtaining a rendered sub-object audio signal from the first multi-channel audio signal;
rendering the key object audio signal; and
obtaining the rendered first multi-channel audio signal by using the rendered sub-object audio signal and the rendered key object audio signal.

11. An electronic device comprising:
memory storing one or more instructions; and
at least one processor configured to execute the one or more instructions stored in the memory,
wherein the one or more instructions, when executed by the at least one processor individually or collectively, cause the electronic device to:
determine, as a key object audio signal, at least one object audio signal among a plurality of object audio signals,
determine, as a sub-object audio signal, an object audio signal, other than the key object audio signal, among the plurality of object audio signals,
obtain a multi-channel audio signal by using the key object audio signal and the sub-object audio signal, and
generate a bitstream by compressing the key object audio signal and the multi-channel audio signal.

12. The electronic device of claim 11, wherein the one or more instructions, when executed by the at least one processor individually or collectively, cause the electronic device to:
obtain a bed channel audio signal which is a channel based audio signal,
render each of the bed channel audio signal, the key object audio signal, and the sub-object audio signal, and
obtain the multi-channel audio signal by mixing the rendered bed channel audio signal, the rendered key object audio signal, and the rendered sub-object audio signal.

13. The electronic device of claim 12, wherein the one or more instructions, when executed by the at least one processor individually or collectively, cause the electronic device to:
compress the key object audio signal,
obtain a decompressed key object audio signal from the compressed key object audio signal, and
obtain the multi-channel audio signal by rendering the decompressed key object audio signal and the sub-object audio signal.

14. The electronic device of claim 13, wherein the one or more instructions, when executed by the at least one processor individually or collectively, cause the electronic device to compress the key object audio signal by using an encoder that is used to compress the multi-channel audio signal.

15. The electronic device of claim 11, wherein metadata of each of the plurality of object audio signals comprises spatial information of objects respectively corresponding to the plurality of object audio signals, and
wherein the spatial information comprises at least one of information about a distance of each object, information about an elevation angle, or information about an azimuth angle.

16. The electronic device of claim 11, wherein the one or more instructions, when executed by the at least one processor individually or collectively, cause the electronic device to:
determine mobility of each of a plurality of objects based on spatial information of each of the plurality of objects respectively corresponding to the plurality of object audio signals;
determine respective importance levels of the plurality of object audio signals based on the mobility of each of the plurality of objects and respective volumes of the plurality of object audio signals; and
determine, as key object audio signals, a preset number of object audio signals having a high importance level among the importance levels.
